(19) United States
(12) Patent Application Publication
(10) Pub. No.: US 2017/0316783 A1
(43) Pub. Date: Nov. 2, 2017

(54) SPEECH RECOGNITION SYSTEMS AND METHODS USING RELATIVE AND ABSOLUTE SLOT DATA

(71) Applicant: GM GLOBAL TECHNOLOGY OPERATIONS LLC, Detroit, MI (US)

(72) Inventors: RON M. HECHT, RA'ANANA (IL); ARIEL TELPAZ, RA'ANANA (IL); YAEL SHMUELI FRIEDLAND, TEL AVIV (IL); ELI TZIRKEL-HANCOCK, RA'ANANA (IL)

(73) Assignee: GM GLOBAL TECHNOLOGY OPERATIONS LLC, Detroit, MI (US)

(21) Appl. No.: 15/141,596

(22) Filed: Apr. 28, 2016

(51) Int. Cl. G10L 17/22; G10L 15/18; G06F 17/30; H04M 1/60

(52) U.S. Cl. CPC G10L 17/22; H04M 1/6041; G06F 17/30766; G06F 17/30769; G10L 15/1815

(57) ABSTRACT

Methods and systems are provided for managing speech of a speech system. In one embodiment, a method includes: receiving, by a processor, relative information comprising graph data from at least one relative data datasource; processing, by a processor, the graph data of the relative information to determine at least one of an association and a relationship associated with an element defined in the speech system; and storing, by a processor, the at least one of association and relationship as relative slot data for use by at least one of a speech recognition method and a dialog management method.

### TECHNICAL FIELD

The technical field generally relates to speech systems, and more particularly relates to methods and systems for utilizing relative data in speech systems.

### BACKGROUND

Vehicle speech systems perform speech recognition or understanding of speech uttered by occupants of the vehicle. The speech utterances typically include commands that communicate with or control one or more features of the vehicle or other systems that are accessible by the vehicle. A speech dialog system of the vehicle speech system generates spoken commands in response to the speech utterances.

For example, a vehicle speech system may receive speech utterances from a user directed to a phone system. The speech utterances can indicate to call a certain person. It is often the case that the user describes the certain person to the speech system using relative information. For example, a user may utter “call my boss, john.” The speech system may not understand “my boss” and/or the user's contact list may not indicate that John is the boss. Multiple dialog prompts may be generated asking for more information before the correct John is selected to be called.

Accordingly, it is desirable to provide improved methods and systems for performing speech recognition and dialog generation using relative information. Furthermore, other desirable features and characteristics of the present invention will become apparent from the subsequent detailed description and the appended claims, taken in conjunction with the accompanying drawings and the foregoing technical field and background.

### SUMMARY

Accordingly, methods and systems are provided for managing speech of a speech system. In one embodiment, a method includes: receiving, by a processor, relative information comprising graph data from at least one relative data datasource; processing, by a processor, the graph data of the relative information to determine at least one of an association and a relationship associated with an element defined in the speech system; and storing, by a processor, the at least one of association and relationship as relative slot data for use by at least one of a speech recognition method and a dialog management method.

In another embodiment, a system includes a first non-transitory module that receives, by a processor, relative information comprising graph data from at least one relative data datasource. The system further includes a second non-transitory module that processes, by a processor, the graph data of the relative information to determine at least one of an association and a relationship associated with an element defined in the speech system, and that stores, by a processor, the at least one of association and relationship as relative slot data for use by at least one of a speech recognition method and a dialog management method.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIGS. 2 and 3 are sequence diagrams illustrating methods of obtaining relative information for the speech system in accordance with various exemplary embodiments; and

FIG. 4 is a flowchart illustrating a method that may be performed by the speech system to process the received relative information in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the modules described herein can be combined and/or partitioned into additional modules in various embodiments.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of steering control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

In accordance with exemplary embodiments of the present disclosure a speech system 10 is shown to be included within a vehicle 12. In various exemplary embodiments, the speech system 10 provides speech recognition or understanding and a dialog for one or more vehicle systems through a human machine interface module (HMI) module 14. Such vehicle systems may include, for example, but are not limited to, a phone system 16, a navigation system 18, a media system 20, a telematics system 22, a network system 24, or any other vehicle system that may include a speech dependent application. As can be appreciated, one or more embodiments of the speech system 10 can be applicable to other non-vehicle systems having speech dependent applications and thus, is not limited to the present vehicle example. The HMI module 14 includes, at a minimum a recording device for recording speech utterances 28 of a user and an audio and/or visual device for presenting a dialog 30 or any other multimodal interaction to a user.

The speech system 10 and/or the HMI module 14 communicate with the multiple vehicle systems 16-24 through a communication bus and/or other communication means 26 (e.g., wired, short range wireless, or long range wireless). The communication bus can be, for example, but is not limited to, a controller area network (CAN) bus, local interconnect network (LIN) bus, or any other type of bus.

The speech system 10 includes a speech recognition module 32 and a dialog manager module 34. As can be appreciated, the speech recognition module 32 and the dialog manager module 34 may be implemented as separate speech systems and/or as a combined speech system 10 as shown. In general, the speech recognition module 32 receives and processes the speech utterances 28 from the HMI module 14 using one or more speech recognition or understanding techniques that rely on semantic interpretation and/or natural language understanding. The speech recognition module 32 generates one or more possible results from the speech utterance (e.g., based on a confidence threshold) and provides the possible results to the dialog manager module 34.

The dialog manager module 34 manages a dialog based on the results. In various embodiments, the dialog manager module 34 determines the next dialog prompt 30 to be generated by the speech system 10 in response to the results. The next dialog prompt 30 is provided to the HMI module 14 to be presented to the user.

As will be discussed in more detail below, the speech system 10 further includes a slot data manager module 36 that manages slot data stored in a slot data datastore 38. The slot data is used by the speech recognition module 32 and/or the dialog manager module 34 to process the speech utterances 28 and/or to manage the dialog 30. The slot data includes absolute slot data 40 and relative slot data 42.

The absolute slot data 40 includes absolute values of elements used in speech processing methods and/or dialog management methods. For example, the elements for a contact person related to the phone system 16 can include, but is not limited to a first name, a last name, a mobile phone, a home phone, etc. In such example, the absolute slot data 40 includes the absolute values for the elements associated with each contact in a user's contact list. The user's contact list can be obtained from the phone system 16, a personal device 43 associated with the vehicle 12 such as a cell phone, tablet, computer, etc., and/or entered by a user directly into the vehicle 12 via, for example, the HMI module 14. As can be appreciated, the absolute slot data 40 can include absolute values for other elements (other than a contact) as the disclosure is not limited to the present examples.

The relative slot data 42 includes relative values of elements used in speech processing methods and/or dialog management methods. For example, the relative values for a contact can indicate a relationship (i.e., mom, dad, sister, husband, etc.) or other association (i.e., boss, group leader, colleague, etc.). As can be appreciated, the relative slot data 42 can include relative values for other elements (other than a contact) as the disclosure is not limited to the present examples.

The slot data manager module 36 communicates with one or more relative data datasources 44-48 to obtain relative information 50-54. The relative data datasources 44-48 include internet sites or accessible databases that maintain the relative information 50-54 for use by their respective application. The slot data manager module 36 makes use of their relative information 50-54 to populate the relative slot data 42 in the slot data datastore 38. For example, given the contact example discussed above, various relative data datasources 44-48 (e.g., Geni, People Finder, or other organization websites) maintain relative information 50-54 about people including their relationships or associations with other people. The relationships or associations can be work relationships, familial relationships, social relationships, etc. The relative information 50-54 is typically maintained by the relative data datasources 44-48 in a graph format, such as a tree format, or other graph format. The slot data manager module 36 obtains the relative information 50-54 in the graph format from one or more of the relative data datasources 44-48 and processes the relative information 50-54 to determine the relative slot data 42.

In various embodiments, the slot data manager module 36 obtains the relative information 50-54 based on an initialization of absolute information (e.g., first time establishing a contact or contact list, etc.). In various embodiments, the slot data manager module 36 obtains the relative information 50-54 in realtime, for example, based on a speech utterance 28 of a user that contains relative language (e.g., “Call Omer from Mo organization,” “Call Eli from ATCI,” “Call Eli from UXT,” “Call cousin Bob,” “Call Rob's wife,” “Call head of SSV group,” etc.). As can be appreciated, the relative information 50-54 can be obtained for a single element at a time or for multiple elements at a time.

In various embodiments, the slot data manager module 36 processes the relative information 50-54 by learning the movement on the graph and learning the relationships/associations associated with each movement on the graph (e.g., given an organization chart of an entity, lateral movement may indicate a colleague, upward movement may indicate a boss, etc.). The slot data manager module 36 extracts the learned relationships/associations relative to a particular element (e.g., the user) and stores the relationships/associations as the relative slot data 42. In various embodiments, the slot data manager module 36 extracts the learned relationships/associations for known elements (e.g., names already stored in the contact list) relative to the particular element (e.g., the user). In various embodiments, the slot data manager module 36 extracts relationships/associations for additional elements (e.g., names not within the contact list) within a defined proximity (or other metric associated with the graph) and stores the relative slot data 42 for the additional elements (e.g., builds additional contacts based on the relative information).

In various embodiments, the slot data manager module 36 stores the relative information 50-54 in graph format in the slot data datastore 38 in addition to the slot data. In such embodiments, the slot data manager module 36 presents the relative information 50-54 to the user (graphically or textually via the HMI module 14) for confirmation and/or disambiguation of the relative information 50-54.

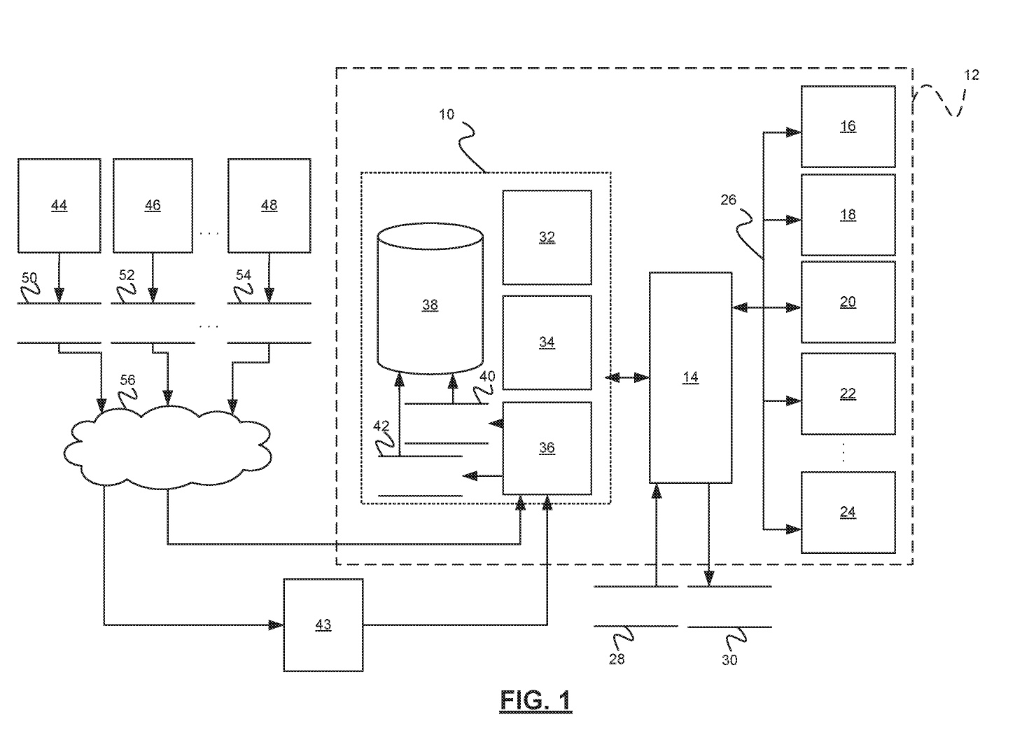

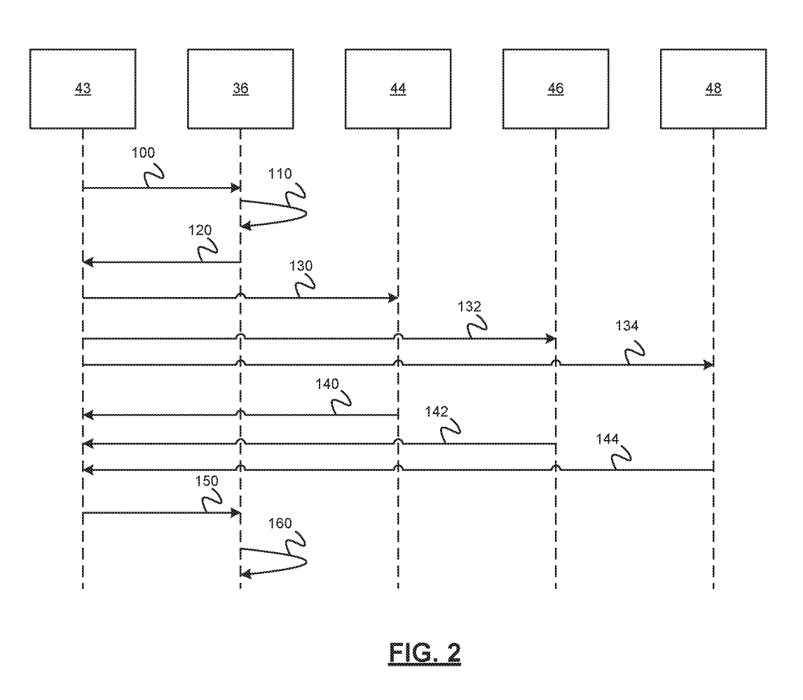

In various embodiments, the slot data manager module 36 communicates indirectly with the relative data datasources 44-46 through, for example, the personal device 43 and a network 56 to obtain the relative information 50-54. For example, as shown in more detail in FIG. 2 and with continued reference to FIG. 1, the personal device 43 may be paired with the vehicle 12 at 100 and the contact list (or other absolute elements) are downloaded and parsed into absolute slot data 40 for use by the speech recognition module 32 and/or the dialog manager module 34 at 110. In response to the downloaded data, the slot data manager module 36 of the speech system 10 communicates a request for relative information to the personal device 43 at 120. The personal device 43 communicates one or more requests to one or more of the relative data datasources 44-48 to capture the relative information 50-54 for a particular element or multiple elements at 130-134. The relative data datasources 44-48 communicate the relative information 50-54 back to the personal device 43 at 140-144. In response, the personal device 43 communicates the relative information 50-54 back to the data slot manager module 36 at 150. The data slot manager module 36 processes the relative information 50-54 to determine the relative slot data 42 and stores the relative slot data 42 in the slot data datastore 38 at 160 for use by the speech system 10.

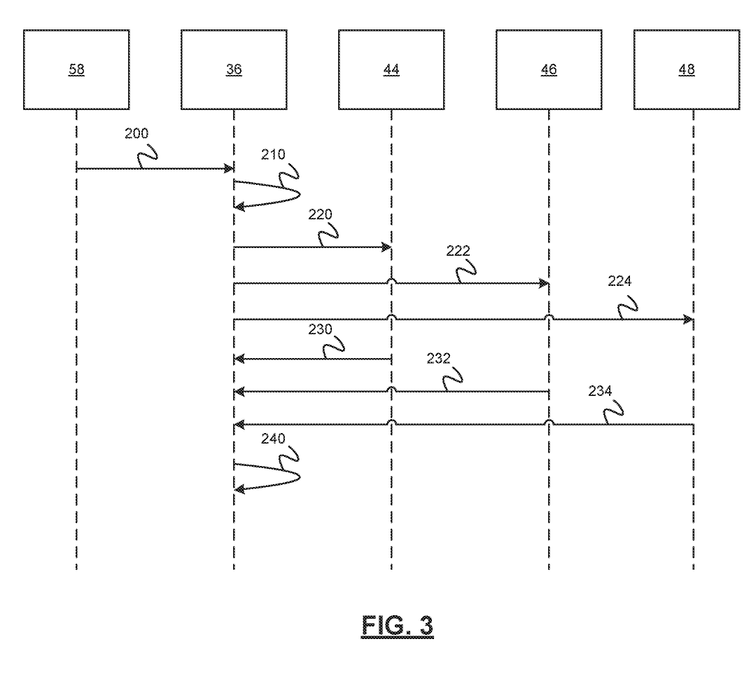

In various other embodiments, as shown in FIG. 1, the data slot manager module 36 communicates directly with the relative data datasources 44-48 (e.g., through the network 56) to obtain the relative information 50-54. For example, as shown in more detail in FIG. 3 and with continued reference to FIG. 1, a user communicates a speech utterance 28 to the speech system 10 at 200. In response, the data slot manager module 36 processes the speech utterance 28 at 210 and communicates a request directly to one or more of the relative data datasources 44-48 to capture the relative information 50-54 for a particular element or multiple elements associated with the speech utterance 28 at 220-224. The relative data datasources 44-48 communicate the relative information 50-54 back to the data slot manager module 36 at 230-234. The data slot manager module 36 processes the relative information 50-54 to determine the relative slot data 42 and stores the relative slot data 42 in the slot data datastore 38 at 240 for use by the speech system 10.

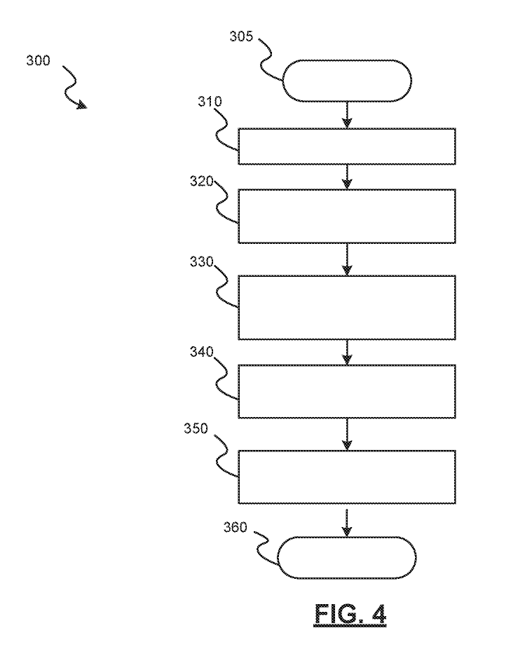

Referring now to FIG. 4, a flowchart illustrates a method 300 that may be performed by the speech system 10 in accordance with various exemplary embodiments. As can be appreciated in light of the disclosure, the order of operation within the method 300 is not limited to the sequential execution as illustrated in FIG. 4, but may be performed in one or more varying orders as applicable and in accordance with the present disclosure. As can further be appreciated, one or more steps of the method 300 may be added or removed without altering the spirit of the method 300.

As shown, the method 300 may begin at 305. The relative information 50-54 is received at 310 (for example as discussed above with regard to FIG. 2 or FIG. 3). The graph data of the relative information 50-54 is processed by learning the movement on the graph, learning the relationships/associations associated with each movement on the graph, and extracting the learned relationships/associations relative to a particular element for known elements and/or additional elements at 320. The extracted relationships/associations are stored as the relative slot data 42 in the slot data datastore 38 at 330. Optionally, the relative information 50-54 is stored in the slot data datastore 38 at 340 for use in confirmation and disambiguation performed by the speech recognition module 32 and/or the dialog manager module 34. The stored relative slot data 42 is then used in speech recognition methods and/or dialog management methods at 350. Thereafter, the method may end at 360. As can be appreciated, in various embodiments the method 300 may iterate for any number of speech utterances provided by the user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for managing speech of a speech system, comprising:
receiving, by a processor, relative information comprising graph data from at least one relative data datasource;
processing, by a processor, the graph data of the relative information to determine at least one of an association and a relationship associated with an element defined in the speech system; and
storing, by a processor, the at least one of association and relationship as relative slot data for use by at least one of a speech recognition method and a dialog management method.

2. The method of claim 1, further comprising storing the relative information for use in a confirmation method of the speech system.

3. The method of claim 1, further comprising storing the relative information for use in a disambiguation method of the speech system.

4. The method of claim 1, further comprising processing the relative slot data with a speech recognition method to determine a result of speech recognition.

5. The method of claim 1, further comprising processing the relative slot data with a dialog management method to determine a dialog prompt.

6. The method of claim 1, wherein the processing the relative information comprises learning movement on a graph defined by the graph data and learning the at least one of association and relationship based on the movement.

7. The method of claim 1, wherein the relative information is received directly from the relative data datasource.

8. The method of claim 1, wherein the relative information is received indirectly from the relative data datasource through a personal device.

9. The method of claim 1, wherein the relative data datasource comprises an internet site that maintains the relative information.

10. The method of claim 1, wherein the element is a contact person associated with a phone system associated with the speech system.

11. A system for managing speech of a speech system, comprising:
a first non-transitory module that receives, by a processor, relative information comprising graph data from at least one relative data datasource; and
a second non-transitory module that processes, by a processor, the graph data of the relative information to determine at least one of an association and a relationship associated with an element defined in the speech system, and that stores, by a processor, the at least one of association and relationship as relative slot data for use by at least one of a speech recognition method and a dialog management method.

12. The system of claim 11, wherein the second non-transitory module stores the relative information for use in a confirmation method of the speech system.

13. The system of claim 11, wherein the second non-transitory module stores the relative information for use in a disambiguation method of the speech system.

14. The system of claim 11, further comprising a third non-transitory module that processes, by a processor, the relative slot data with a speech recognition method to determine a result of speech recognition.

15. The system of claim 11, further comprising a fourth non-transitory module that processes the relative slot data with a dialog management method to determine a dialog prompt.

16. The system of claim 11, wherein the relative information includes graph data, and wherein the second non-transitory module processes the relative information by learning movement on a graph defined by the graph data and learning the at least one of association and relationship based on the movement.

17. The system of claim 11, wherein the relative information is received directly from the relative data datasource.

18. The system of claim 11, wherein the relative information is received indirectly from the relative data datasource through a personal device.

19. The system of claim 11, wherein the relative data datasource comprises an internet site that maintains the relative information.

20. The system of claim 11, wherein the element is a contact person associated with a phone system associated with the speech system.
